(19) United States
(12) Patent Application Publication
(10) Pub. No.: US 2014/0224028 A1
(43) Pub. Date: Aug. 14, 2014

(54) PRESSURE SENSOR ARRANGEMENT FOR DETECTING A PRESSURE OF A FLUID MEDIUM IN A MEASUREMENT AREA

(71) Applicants: Alexander Lux, Ostfildern (DE); Martin Mast, Gerlingen (DE)

(72) Inventors: Alexander Lux, Ostfildern (DE); Martin Mast, Gerlingen (DE)

(21) Appl. No.: 14/124,110

(22) PCT Filed: Apr. 27, 2012
(86) PCT No.: PCT/EP2012/057745

§ 371 Date: Mar. 17, 2014

(30) Foreign Application Priority Data
Jun. 21, 2011 (DE) 10 2011 077 868.3

(51) Int. Cl. G01L 9/00

(52) U.S. Cl. CPC G01L 9/0041
USPC 73/728; 29/428

(57) ABSTRACT

A pressure sensor system for acquiring a pressure of a fluid medium in a measurement chamber, and a method for the production thereof, are provided, having a sensor housing, at least one sensor element that is situated on a bearer such that it can be exposed to the medium in order to measure a pressure of the medium, and an evaluation circuit for outputting a signal that indicates the pressure acting on the sensor element. The evaluation circuit is situated outside the medium and is energetically connected to the sensor element in contactless fashion. The bearer is connected to the sensor housing such that the evaluation circuit is situated inside the sensor housing.

### CROSS REFERENCE TO RELATED APPLICATION

The present application is the national stage entry of International Patent Application No. PCT/EP2012/057745, filed on Apr. 27, 2012, which claims priority to Application No. DE 10 2011 077 868.3, filed in the Federal Republic of Germany on Jun. 21, 2011.

### BACKGROUND INFORMATION

From the existing art, various devices and methods are known for acquiring pressures of fluid media, such as gases and liquids. Pressure, as a measurement quantity, is a non-directional force action that occurs in gases and liquids and that acts at all sides. Dynamically acting and statically acting measurement value recording elements, or sensors, are used to measure pressures. Dynamically acting pressure sensors are used only to measure pressure fluctuations in gaseous or liquid media. The pressure measurement can take place directly, via membrane deformation, or via a force sensor.

In particular for the measurement of very high pressures, it would be adequate simply to expose an electric resistance to the medium, because all known resistances have, to a greater or lesser degree, a functional relationship to pressure. However, it is difficult to realize the suppression of the simultaneous functional dependence of the resistances on temperature and the pressure-tight routing of their electrical terminals out of the pressure medium.

The most widely used method of pressure acquisition therefore uses, first of all, a thin membrane as a mechanical intermediate stage that is exposed to the pressure on one side and that deflects elastically to a greater or lesser degree under the influence thereof, in order to obtain the signal. Its thickness and diameter can be adapted to the respective pressure range within broad limits. Low pressure measurement ranges result in comparatively large membranes having elastic deflection that can be in the range of from 0.1 to 1 mm. However, high pressures require thicker membranes having a smaller diameter, which for the most part are elastically deflected by only a few micrometers. Such pressure sensors are described for example in: Konrad Reif (publisher), Sensoren im Kraftfahrzeug [Sensors in the Motor Vehicle], 1st ed., 2010, p. 80-82 and p. 134-136.

In particular, micromechanical semiconductor pressure sensors are known that have a frame made of a semiconductor substrate, and a membrane situated on the frame. On the membrane, there are attached various piezoresistive measurement resistances that change their resistance value when there is a deformation of the membrane, or of the resistances. The piezoresistive measurement resistances are standardly situated on the side of the membrane facing away from the pressurized medium, as described for example in German Application Nos. DE 10 2007 052 364 or DE 10 2004 006 199.

German Application No. DE 10 2004 006 199 describes a pressure sensor system that includes as sensor element a micromechanical sensor chip having a membrane, the membrane spanning a cavern in the rear side of the chip. The sensor chip is mounted on a metallic housing base, via an intermediate bearer made of glass containing sodium. The pressure that is to be acquired is applied to the membrane via a pressure supply line in the housing base that also extends through the glass bearer and opens into the cavern of the sensor chip.

German Application No. DE 10 2007 052 364 describes a pressure sensor system having at least one sensor chip as sensor element, mounted on a housing base via at least one intermediate bearer, the semiconductor material of the sensor chip and the material of the housing base having different coefficients of thermal expansion. At least one intermediate bearer is realized in the form of a ceramic bearer whose coefficient of thermal expansion is adapted to a coefficient of thermal expansion of the semiconductor material of the sensor chip.

Pressure sensors are also known in which the sensor element is accommodated in a measurement cell. The measurement cell has a separating membrane having an internal oil reservoir. During the measurement, the pressurized medium produces a pressure that is transmitted to the sensor element via the separating membrane and the internal oil reservoir.

German Application No. DE 101 28 010 describes a pressure sensor system in which a measurement recording element is integrated as a sensor element in a bearer, and is energetically connected, in contactless fashion, to an evaluation circuit. In particular, it is described that the measurement recording element can be situated in a tire of a motor vehicle, and the evaluation circuit can be situated in the interior of the motor vehicle. The measurement recording element and the evaluation circuit are correspondingly situated on different, spatially separated components.

Despite the numerous advantages of the pressure sensor systems known from the existing art, there is still potential for improving them. Thus, for example the use of the silicon micromechanical system for the sensor element, and protection by an oil reservoir, is relatively expensive and has the disadvantage that the robustness of the sensor system is limited. In addition, in other strategies it is sought to exert pressure on the membrane rear side, i.e., the region of the membrane facing away from the pressurized medium, with the silicon micromechanical system. Due to the solidity of the standard glass base, however, there is a limitation here due to the burst pressure, so that this pressure sensor system is not suitable for pressures greater than 100 bar. Pressure systems having metal membranes have very high requirements of precision, with very thin membranes. Such thin membranes are very expensive to shape, and during the connection or assembly process warping can occur, so that a precise pressure measurement is no longer possible. This is equally true of ceramic membrane elements. In these elements, there is in particular the problem of tightness against the medium being measured over the lifespan of the membrane, so that their range of use is limited to approximately 200 bar. In particular in the determination of high pressures in the range of more than 200 bar, due to the required material strength only very small deformations of the membrane are present, so that, correspondingly, only small signals can be outputted. These signals must therefore be amplified. When there is imprecision in the material production, measurement errors therefore occur, and the measurement errors are therefore correspondingly amplified or enlarged, so that as the pressure increases the pressure determination can become more imprecise. This means that for measurement in high-pressure applications a suitable layer construction is required, as well as very high geometric tolerance demands on the sensor element. In addition, the electrical signals are very small, so that a large electrical amplification is necessary for processing and output. This amplification is applied equally to the useful signal and to disturbing quantities.

### SUMMARY

Therefore, a pressure sensor system is proposed that at least largely avoids the disadvantages of known pressure sensors, and that can be applied over a large pressure range.

The present invention is fundamentally suitable for acquiring a pressure at any location of use, in particular in the range of the pressures that are to be measured in a motor vehicle.

An idea of the present invention is to couple the sensor element to an evaluation circuit energetically and without direct electrical connecting contacts, in contactless fashion, via a coil system, e.g., inductively and/or capacitively, it being possible to situate the sensor element directly in the pressure medium that is to be measured.

Correspondingly, a pressure sensor system is proposed for acquiring a pressure of a fluid medium in a measurement chamber. In addition, given corresponding integration of the respective components, further physical and/or chemical properties of the fluid medium can be determined, including for example a temperature, a further pressure, a flow property, or one or more other properties. The measurement chamber can in principle be any space in which the fluid medium, i.e., a gas and/or a liquid, is accommodated, either still or flowing. In particular, the measurement chamber can be a part of a fuel system. The pressure sensor system can therefore be used or adapted in particular for acquiring a fuel pressure.

In the context of the present invention, a contactless energetic coupling is understood to be a coupling in which at least one item of information, in particular at least one measurement signal, is transmitted in contactless fashion via an exchange of energy. In particular, the contactless energetic coupling can be or can include a contactless electrical coupling, for example an inductive and/or capacitive electrical coupling and/or an exchange of electromagnetic or magnetic signals. For example, electrical signals can be exchanged in contactless fashion in the form of voltage signals and/or current signals. The expression “in contactless fashion” is here to be understood as meaning that the energy exchange, in particular the exchange of electrical signals, takes place in wireless fashion, i.e., without a direct electrically conductive connection.

The sensor system can include at least one pressure connection that can be set in a wall of the measurement chamber and can be adapted as a threaded collar. The pressure connection can in particular be fastened in the wall of the measurement chamber by one or more connecting elements, for example by at least one outer threading that engages in an inner threading of the wall of the measurement chamber. However, other fastenings are also alternatively or additionally possible in principle. The fastening can in particular be pressure-tight and/or media-tight.

A pressure sensor system according to the present invention includes a sensor housing, at least one sensor element situated on a bearer such that it can be exposed to the medium in order to measure a pressure of the medium, and an evaluation circuit for outputting a signal that indicates the pressure acting on the sensor element, the evaluation circuit being situated outside the medium and being energetically connected in contactless fashion to the sensor element, the bearer being connected to the sensor housing such that the evaluation circuit is situated inside the sensor housing. A sensor housing is to be understood as a housing that completely or partially surrounds, or accommodates, the evaluation circuit. However, it is also possible for the evaluation circuit to be partly situated outside the sensor housing. In principle, here all components are to be understood that separate the evaluation circuit from the medium and protect it from external influences.

The supply of electric voltage to the sensor element and the reading out from the sensor element can take place by, for example, an inductive connection. Due to the pressure sensor system according to the present invention, electrical connecting elements such as bonding wires from the sensor element to the evaluation circuit can be omitted. Such connecting elements are standardly sensitive, in particular pressure-sensitive. In addition, when exposed to the medium such connecting elements can corrode and/or can experience mechanical damage, for example due to the pressure. In the pressure sensor system according to the present invention, no through-contacting going through the medium need take place, and therefore it is also not necessary to provide a seal for this. The sensor element of the pressure sensor system according to the present invention can be passivated, so that it does not offer any electrical and/or mechanical attack points for the medium. Such passivation layers can include for example silicon nitride, silicon carbide, or the like. Above all, the pressure sensor system according to the present invention can achieve an increased media robustness in comparison with sensor housings made of plastics and other components of pressure sensor systems made of plastics and known from the existing art, because no electrical connections or other sensitive components have to be sealed. Equally, the temperature resistance can also be increased, above all in comparison with sensor housings made of plastics and other components of pressure sensor systems made of plastics and known from the existing art. The pressure sensor systems according to the present invention can likewise have a housing made of plastic and can nonetheless be suitable for pressures greater than 10 bar, because no direct electrical connections have to be provided that would have to be sealed. Correspondingly, the sensor element can be designed separately or individually for each pressure range that is to be expected. In particular, precise membranes can be set in a wide pressure range.

The bearer can be made of an electrically non-conductive material. This can for example be a ceramic material. In this way, an undisturbed electrical and contactless connection can be achieved between the evaluation circuit and the sensor element.

The bearer can be permeable to magnetic fields. This is relevant in particular in the case of an inductive connection between the evaluation circuit and the sensor element, so that an undisturbed electrical voltage can be induced in the evaluation circuit.

The pressure sensor system can in addition include a pressure connection with which the bearer of the sensor element is connected so as to be sealed against the medium. Such a pressure connection is used to attach or fasten the pressure sensor system for example to a wall of the measurement chamber. Due to the media-tight connection between the bearer and the pressure connection, the evaluation circuit is protected against the medium.

The bearer can for example be made completely or partly of a ceramic material. The pressure connection can in particular be made completely or partly of a metal or a metal compound, for example of steel. In this way, a particularly robust pressure sensor system can be created that nonetheless enables an undisturbed electrical and contactless connection between the evaluation circuit and the sensor element. In order to connect a ceramic bearer to a metallic pressure connection, for example one or more of the following techniques can be used: a soldered connection, a welded connection, or a glued connection. A connection can for example also be produced and/or promoted by completely or partly metallizing the ceramic bearer before the connection with the metallic pressure connection, for example by applying at least one metallic layer thereon, for example a nickel layer, a gold layer and/or a silver layer. Subsequently, a soldering to the pressure connection can take place.

In the case of a soldered connection, for example a solder paste is pressed and/or dispensed onto the metallic pressure connection with a defined thickness and/or strength, or a solder disk or small plate is positioned or situated on the metallic pressure connection. Subsequently, the ceramic bearer is positioned, i.e., brought into its final position relative to the pressure connection, and, in a temperature step, is heated to a temperature above the melting temperature of the solder. The heating can for example take place through a standard oven process applied to the entire component, or through a local heating of the pressure connection with solder and ceramic bearer through induction or using a defocused laser beam. Here, the lower melting temperature of the solder compared to the other components is to be emphasized. Thus, only the solder is transferred into the liquid aggregate state. The metallic pressure connection and the ceramic bearer remain in the solid aggregate state. A mechanical bond is provided by the subsequent cooling process.

In the case of a welded connection, for example the metallic pressure connection and the ceramic bearer are positioned, i.e., brought into their final positions relative to one another. A welding filler material can be present between the pressure connection and the ceramic bearer. Subsequently, using a laser beam to create a local heating, the bonding point between the pressure connection and the ceramic bearer is heated such that the two materials in the region adjoining one another enter into the liquid aggregate state, and a material mixture and/or material diffusion takes place. The welding filler material, as a thermal intermediate layer, can also act to align the melting temperatures. A mechanical bond is provided by the subsequent cooling process. The cooling process is to be controlled and monitored in order to minimize mechanical tensions between the two materials.

The pressure sensor system can in addition include a housing base that can be situated on an end of the pressure connection, and the bearer of the sensor element can be provided on the pressure connection such that the bearer stands out from a plane of the housing base or is situated in a plane of the housing base. In this way, the sensor housing can be provided on the housing base in a particularly simple manner, and can protect the evaluation circuit from external influences.

The evaluation circuit can be situated directly on the bearer of the sensor element. In this way, the distance between the sensor element and the evaluation circuit can be kept as short as possible, so that the probability of a disturbance of the electrical connection between them can be minimized.

A further pressurized medium can be situated in the sensor housing, so that a counter-pressure can be applied to the bearer of the sensor element and the pressure sensor system is adapted for a differential pressure measurement. In this way, the above-described advantages can also be achieved in the case of an application for measurement of differential pressures.

A method for producing such a pressure sensor system can include the following steps, preferably in the indicated sequence:
attaching a sensor element to a bearer, in particular by soldering, glazing, or gluing, such that it can be exposed to a medium in order to measure a pressure of the medium;
providing an evaluation circuit for outputting a signal that indicates the pressure acting on the sensor element, the evaluation circuit being situated outside the medium and being energetically connected to the sensor element in contactless fashion;
providing a sensor housing,
the bearer being connected to the sensor housing such that the evaluation circuit is situated inside the sensor housing.

In addition, a pressure connection can be provided, in particular a pressure connection made of metal, and the bearer of the sensor element can be made in particular of a ceramic material and can be connected to the pressure connection so as to be sealed against the medium, in particular by soldering or welding.

In sum, it can be said that the sensor element can be attached to a ceramic by soldering, gluing, or glazing. Due to the media-tight connection between the steel and the ceramic, the electronics compartment is protected from the measurement medium. There is also no through-contacting that would have to be sealed. Therefore, an increased media robustness is provided, above all in comparison with sensors made of plastics. In addition, the temperature resistance is increased, above all in comparison with plastics, and expanded pressure ranges greater than 10 bar are possible.

Further optional details and features of exemplary embodiments of the present invention are described in the following with reference to the accompanying drawings.

### BRIEF DESCRIPTION OF THE DRAWINGS

FIG. 1 shows a sectional view of a pressure sensor system according to a first exemplary embodiment.

FIG. 2 shows a sectional view of a pressure sensor system according to a second exemplary embodiment.

FIG. 3 shows a sectional view of a pressure sensor system according to a third exemplary embodiment.

FIG. 4 shows a sectional view of a pressure sensor system according to a fourth exemplary embodiment.

FIG. 5 shows a sectional view of a pressure sensor system according to a fifth exemplary embodiment.

FIG. 6 shows a sectional view of a pressure sensor system according to a sixth exemplary embodiment.

FIG. 7 shows a sectional view of a pressure sensor system according to a seventh exemplary embodiment.

FIG. 8 shows a sectional view of a pressure sensor system according to an eighth exemplary embodiment.

FIG. 9 shows a sectional view of a pressure sensor system according to a ninth exemplary embodiment.

### DETAILED DESCRIPTION

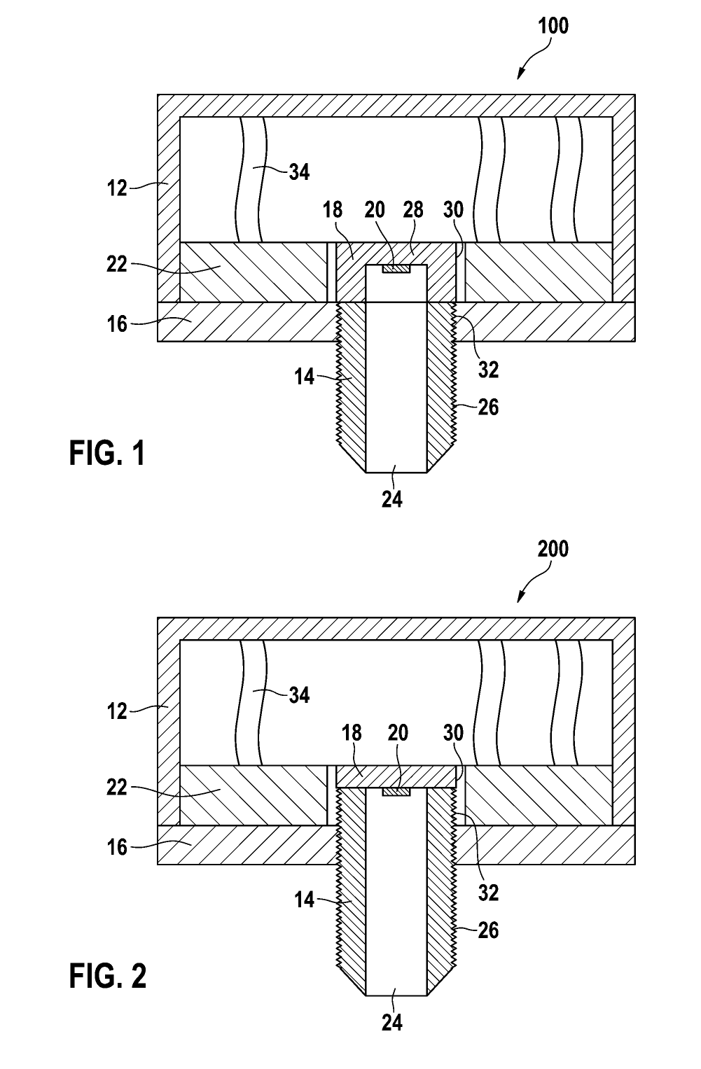

FIG. 1 shows a first exemplary embodiment of a pressure sensor system 100 according to the present invention. Pressure sensor system 100 includes a sensor housing 12, a pressure connection 14, a housing base 16 having a hexagonal shape, a bearer 18, a sensor element 20, and a circuit board 22 having an evaluation circuit not shown in more detail. Pressure connection 14 is adapted as a threaded connector, and is a substantially cylindrical component that has an opening 24 for the pressurized medium that is to be measured in a measurement chamber (not shown), such as a fuel line, and has an outer threading 26. Bearer 18 is adapted with a cup shape, and is made of a material that is electrically nonconductive but is permeable to a magnetic field. This can be for example a ceramic material. On an inner side of floor area 28 of the cup shape of bearer 18, sensor element 20 is fastened to bearer 18 by soldering, glazing, or gluing. The details of sensor element 20 are described extensively below. Bearer 18 is fastened to pressure connection 14, for example by welding, soldering, or gluing, such that sensor element 20 is oriented toward opening 24 in pressure connection 14. If bearer 18 is made of a ceramic material, then it can have at least in some regions a metallized surface in the region in which the connection is to be created, in order to be connected to pressure connection 14 by welding or soldering. Wall areas 30 of the cup shape of bearer 18 terminate flush with wall areas 32 of pressure connection 14. In this way, the pressurized medium can act on sensor element 20 directly from the measurement chamber. Due to the particular manner of fastening of sensor element 20 on bearer 18, sensor element 20 is fastened on bearer 18 so as to be sealed against the medium to be measured, i.e., the medium cannot come between bearer 18 and sensor element 20. Likewise, the above-described fastening method provides a similar tight connection between bearer 18 and pressure connection 14. Sensor element 20 can be mounted on the bearer via a glass bearer for stress decoupling. For this purpose, for example an elastic adhesive can be used. This adhesive can also provide thermal decoupling.

Hexagonal housing base 16 is fastened, by a welding process, to pressure connection 14 such that bearer 18 stands out from the plane of housing base 16. Hexagonal housing base 16 provides an engagement surface for a tool, for example a screw wrench, in order to screw pressure connection 14 into a wall of the measurement chamber in which the pressurized medium to be measured is situated, using outer threading 26. Alternatively, pressure connection 14 can have an inner threading that is set up so as to engage in and be placed into a corresponding outer threading of a wall of the measurement chamber.

Circuit board 22 with the evaluation circuit is situated coaxially to bearer 18 on housing base 16, such that an open space is present surrounding bearer 18. At the open space, coil elements (not shown) are situated at the top and/or at the bottom on circuit board 22. Bearer 18 is therefore situated in the plane of circuit board 22, and is thus surrounded by it circumferentially. The details of the evaluation circuit are described in detail below. In addition, the housing is situated on housing base 16 such that circuit board 22 and bearer 18 are accommodated therein. Signals of circuit board 22 can be conducted, for example via S-springs 34, to a connecting plug (not shown) of pressure sensor system 100. Due to the particular type of fastening of bearer 18 to pressure connection 14, the medium cannot move into the interior of sensor housing 12, in which the sensitive evaluation circuit is situated. Further details about the connection are described in detail below, in connection with the production method according to the present invention.

In the following, the signal evaluation according to the present invention of pressure sensor system 100 is described. Pressure sensor system 100 is screwed into a wall of the measurement chamber, which contains a pressurized medium, using outer threading 26 of pressure connection 14. As a result, the medium can move into opening 24 of pressure connection 14 and can act on sensor element 20. In a known manner, a connecting plug of an evaluation unit (not shown) having a pressure indicating device is connected, via S-springs 34, to circuit board 22 and to the evaluation circuit. Sensor element 20 includes a so-called LC oscillating circuit as a measurement recording element, i.e., a circuit made up of a capacitor and a coil. The coil is an inductive component that has a material that influences its inductance, the strength with which the inductance influences the material being a function of the pressure. Corresponding greases or other highly permeable materials, such as an annular core made of correspondingly suitable ferrite, are known from the existing art. When the pressure acting on the measurement recording element changes, the inductance changes as a consequence, and thus the resonant frequency of the oscillating circuit changes. Circuit board 22 having the evaluation circuit includes an oscillator for exciting the oscillating circuit via the coil elements of the evaluation circuit. Because bearer 18 is permeable to a magnetic field, sensor element 20 and the oscillator are correspondingly coupled energetically in contactless fashion, in particular inductively and/or capacitively. In addition, the evaluation circuit includes a tuning device for the frequency tuning of the oscillator, and can provide a signal that is proportional to the pressure acting on sensor element 20. The tuning device can be operated manually or automatically. When the current oscillator frequency agrees with the resonant frequency of the measurement recording element of sensor element 20, the attenuation of the oscillator is significantly higher than in the case of non-agreement of the two last-named frequencies. The strong attenuation in the case of resonance causes a significant reduction of the voltage provided at the output of the evaluation circuit. Thus, the resonant frequency of the oscillating circuit of sensor element 20, and therefore the frequency response characteristic of the voltage provided at the output of the evaluation circuit, stands in a functional relationship to the external quantity that is to be detected by the sensor element, namely the magnitude of the pressure acting on sensor element 20. Correspondingly, the pressure acting on sensor element 20 can be acquired without direct electrical connection to the evaluation circuit. Due to the particular configuration, therefore, the problem of through-contacting is avoided. In particular, in this way more robust materials in comparison with the medium can be used. Depending on the particular application of pressure sensor system 100, these can be metals, metal compounds, alloys thereof, or even plastics. In addition, due to the particular configuration temperature resistance is increased and the pressure to be measured can be acquired or determined in a larger range. This is of interest in particular in the automotive field, where for example pressures of up to 2000 bar prevail in the common rail of a diesel engine.

FIG. 2 shows a second exemplary embodiment of a pressure sensor system 200 according to the present invention. In the following, only the aspects differing from the first exemplary embodiment are described. In particular, identical components are provided with identical reference characters.

In pressure sensor system 200 shown in FIG. 2, bearer 18 of sensor element 20 is adapted in the shape of a disk. Housing base 16 is situated on pressure connection 14 such that pressure connection 14 stands out from the plane of housing base 16 by a distance in the direction toward sensor housing 12. Bearer 18 is situated in the plane of circuit board 22 with the evaluation circuit, and is surrounded by it circumferentially. The measurement design for pressure acquisition is the same as that described in relation to the first exemplary embodiment.

FIG. 3 shows a third exemplary embodiment of a pressure sensor system 300 according to the present invention. In the following, only the aspects differing from the first or second exemplary embodiment are described. In particular, identical components are provided with identical reference characters.

In pressure sensor system 300 shown in FIG. 3, bearer 18 of sensor element 20 is cup-shaped, as in the first exemplary embodiment. Housing base 16 is adapted to pressure connection 14 such that bearer 18 is situated in the plane of housing base 16 and aligns therewith. Circuit board 22 with the evaluation circuit is attached on housing base 16 such that it is situated flatly over bearer 18, or sensor element 20; i.e., an outer side of the floor region of the cup shape of bearer 18 is also covered by circuit board 22. The coil elements of the evaluation circuit are situated at the top or at the bottom on circuit board 22, above sensor element 20. In other respects, the measurement design for pressure acquisition is the same as that described in relation to the first exemplary embodiment.

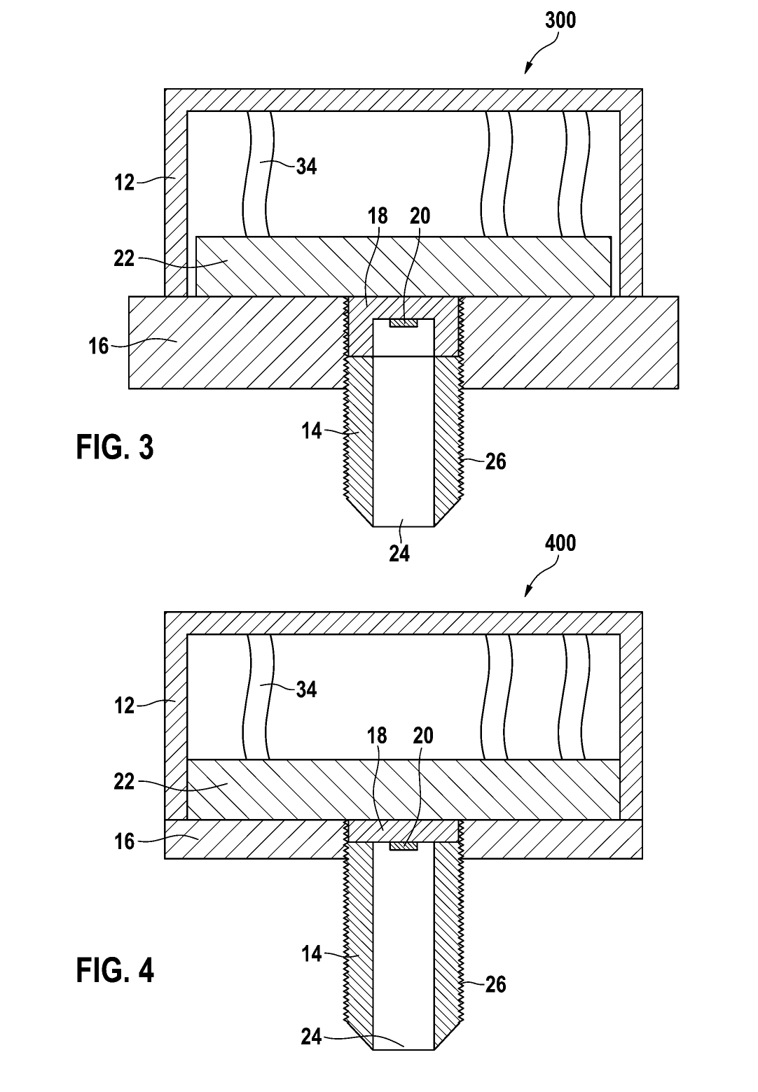

FIG. 4 shows a fourth exemplary embodiment of a pressure sensor system 400 according to the present invention. In the following, only the aspects differing from the previous exemplary embodiments are described. In particular, identical components are provided with identical reference characters.

In pressure sensor system 400 shown in FIG. 4, bearer 18 is disk-shaped, as in the second exemplary embodiment. As in the third exemplary embodiment, housing base 16 is situated or fastened on pressure connection 14 such that bearer 18 is situated in the plane of housing base 16 and is flush therewith. Here as well, as in the third exemplary embodiment, circuit board 22 is situated on housing base 16 such that it extends flatly over bearer 18. The configuration of the coil elements is the same as in the third exemplary embodiment. In other respects, the measurement design for pressure acquisition is the same as that described in relation to the first exemplary embodiment.

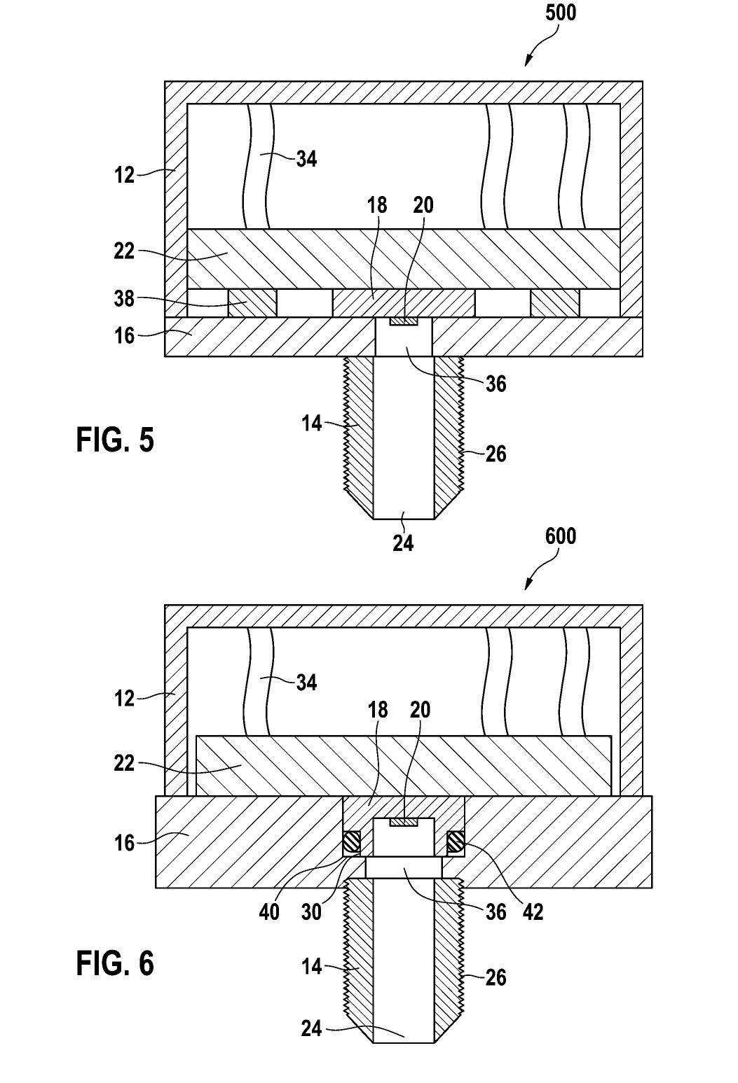

FIG. 5 shows a fifth exemplary embodiment of a pressure sensor system 500 according to the present invention. In the following, only the aspects differing from the previous exemplary embodiments are described. In particular, identical components are provided with identical reference characters.

In pressure sensor system 500 shown in FIG. 5, bearer 18 of sensor element 20 is adapted with a disk shape. Housing base 16 has, in its center region, an opening 36 that is made coaxial to, or flush with, opening 24 in pressure connection 14. Bearer 18 of sensor element 20 is fastened on housing base 16, and not on pressure connection 14, and is situated on the side of housing base 16 facing toward sensor housing 12. Therefore, bearer 18 is fastened to pressure connection 14 indirectly, via housing base 16. On the side of housing base 16 facing sensor housing 12, there is situated an annular intermediate bearer 38 that is positioned coaxial to bearer 18 of sensor element 20. Circuit board 22, with the evaluation circuit, is situated on this intermediate bearer 18, and spans or covers bearer 18. The coil elements of the evaluation circuit are situated at the top or at the bottom on circuit board 22, above sensor element 20. In other respects, the measurement design for pressure acquisition is the same as that described in relation to the first exemplary embodiment.

FIG. 6 shows a sixth exemplary embodiment of a pressure sensor system 600 according to the present invention. In the following, only the aspects differing from the previous exemplary embodiments are described. In particular, identical components are provided with identical reference characters.

In pressure sensor system 600 shown in FIG. 6, bearer 18 of sensor element 20 is made with a cup shape, having an open space at the free end of its outer wall. Housing base 16 has in its center region a depression or open space 40 having an opening 36 as in the previous exemplary embodiment, adapted coaxial to or flush with the opening in pressure connection 14. Bearer 18 of sensor element 20 is not situated on pressure connection 14, but rather in the depression of housing base 16, such that it is situated in the plane of housing base 16 and is flush therewith. Open space 40 in the area of the outer wall of cup-shaped bearer 18 is used to accommodate a seal 42, such as an O-ring, situated between wall area 30 of bearer 18 and open space 40 of housing base 16. Circuit board 22 having the evaluation circuit is situated on housing base 16 such that it covers bearer 18 in a flat manner. The coil elements of the evaluation circuit are situated at the top or at the bottom on circuit board 22, above sensor element 20. In other respects, the measurement design for pressure acquisition is the same as that described in relation to the first exemplary embodiment.

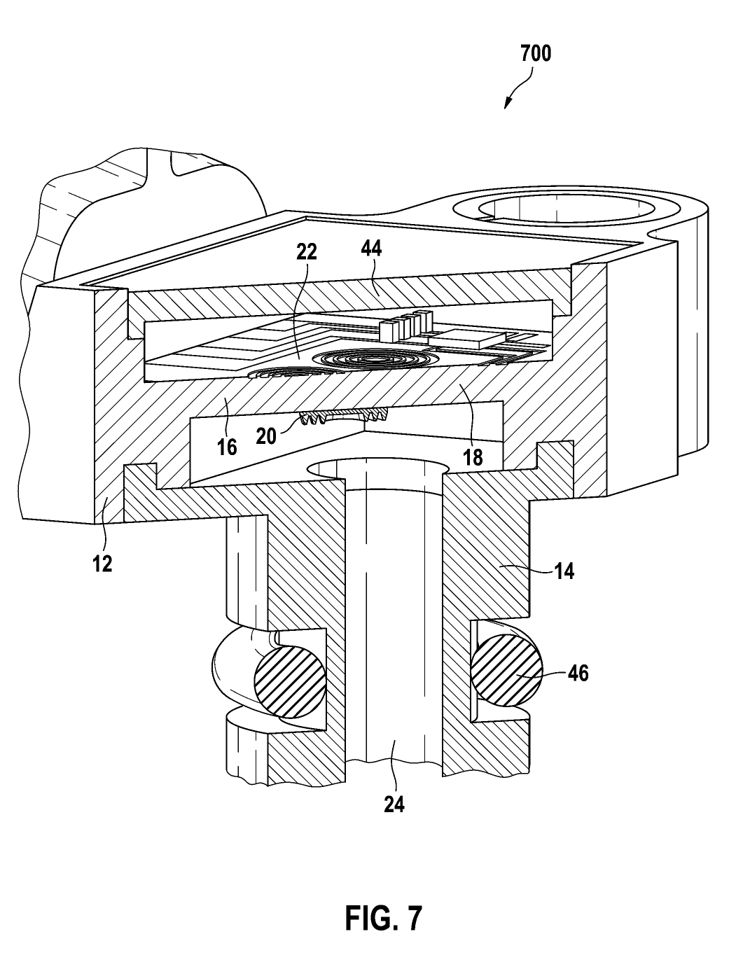

FIG. 7 shows a seventh exemplary embodiment of a pressure sensor system 700 according to the present invention. In the following, only the aspects differing from the previous exemplary embodiments are described. In particular, identical components are provided with identical reference characters.

In pressure sensor system 700 shown in FIG. 7, sensor housing 12 is made of plastic. In particular, housing base 16 and sensor housing 12 are adapted integrally. In the following, the combination, or composite, of these two components is designated sensor housing 12. Sensor housing 12 can be made up of a base plate with walls. The base plate act as bearer 18 of sensor element 20. The base plate has, inwardly, i.e., within the walls and on the side that is oriented toward circuit board 22 with the evaluation circuit, bearer 18 of sensor element 20, and on the outer side, i.e., on the side at which no walls are located and which is oriented toward the pressure medium, the base plate accommodates sensor element 20. In the upper region of the walls, i.e., the region facing away from circuit board 22, sensor housing 12 has an opening. Pressure connection 14 can be fastened to this sensor housing 12 for example by laser welding or ultrasound welding. After the installation of electronic components in the interior of sensor housing 12 and after carrying out a calibration in order to set a characteristic curve for the pressure and the temperature compensation, the opening of sensor housing 12 is sealed with a cover 44. The connection to the pressure can take place either via a seal 46, such as an O-ring in a bore or groove, or by connecting a hose in the area of pressure connection 14. Sensor housing 12 is suitable for pressures up to approximately 50 bar. In other respects, the measurement design for pressure acquisition is the same as that described in relation to the first exemplary embodiment.

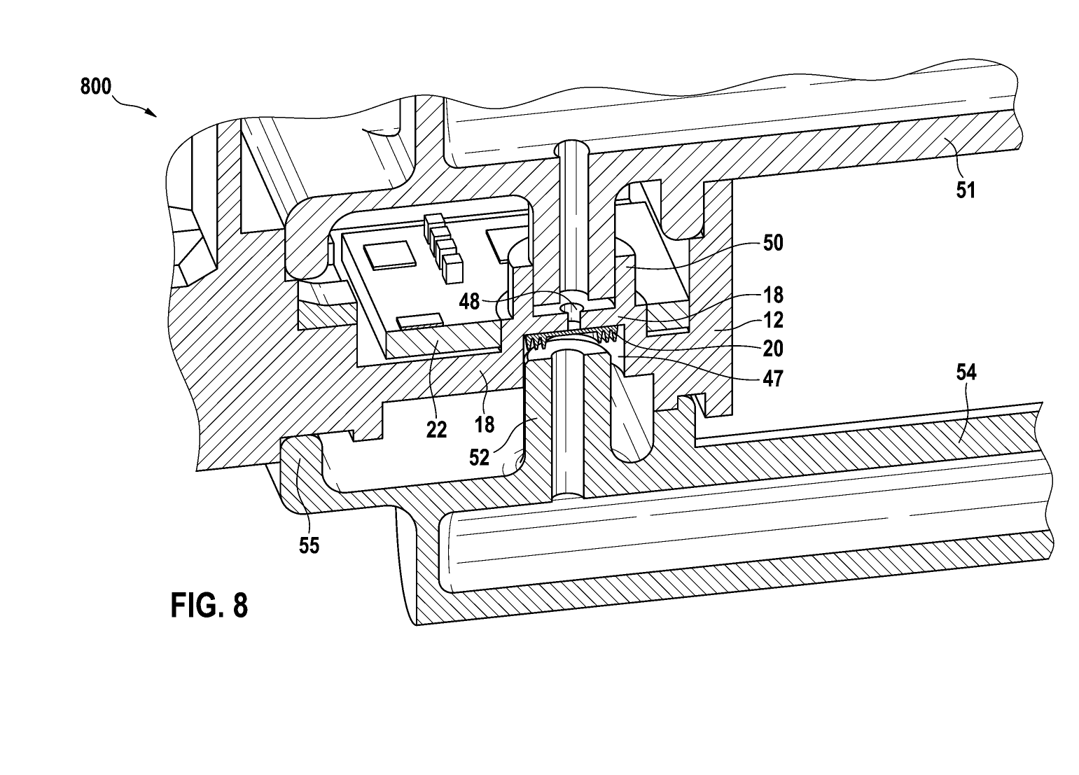

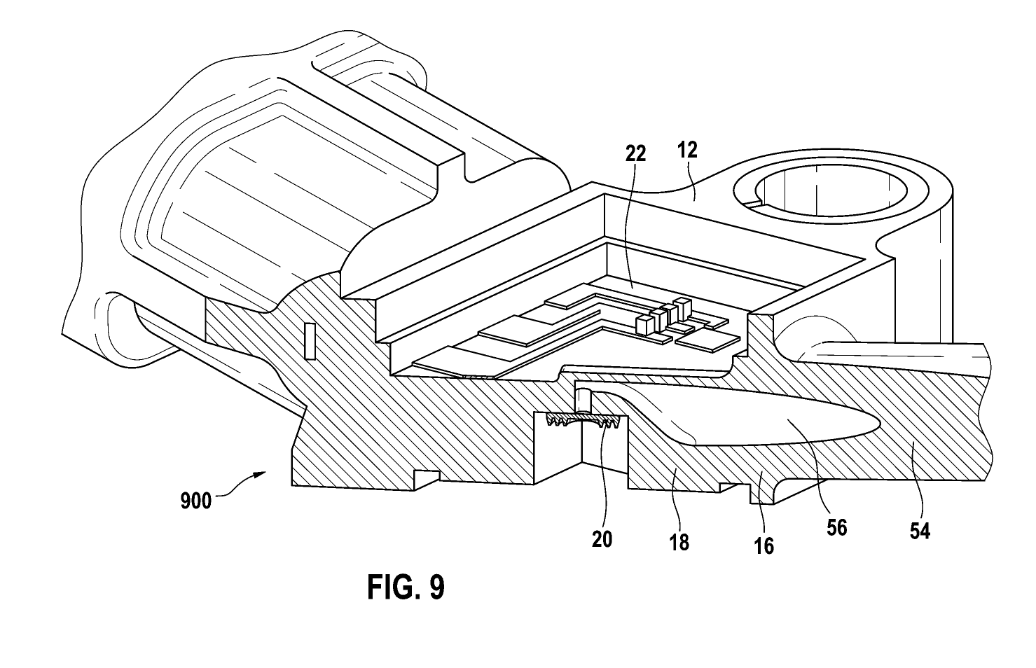

FIG. 8 shows an eighth exemplary embodiment of a pressure sensor system 800 according to the present invention. In the following, only the aspects differing from the previous exemplary embodiments are described. In particular, identical components are provided with identical reference characters.

In pressure sensor system 800 shown in FIG. 8, sensor housing 12 is made of plastic, as in the seventh exemplary embodiment. However, such a plastic housing can be converted for example for low to medium differential pressures, i.e., pressures up to 20 bar. In a differential pressure system, a second pressure is produced going through the interior of sensor housing 12. Here, sensor housing 12 can be made up of a base plate with walls. The base plate acts as bearer 18 of sensor element 20. The base plate has in particular a circular cylindrical depression 47 having a central opening 48 that is covered by sensor element 20. Circuit board 22 is situated on bearer 18, surrounding circular cylindrical depression 47, and is situated coaxial to opening 48. The coil elements of the evaluation circuit are in this case therefore situated next to sensor element 20, or depression 47, in bearer 18, such that an adequate transmission performance can be shown. On the side of depression 47 facing away from sensor element 20, there are situated walls 50 coaxial to opening 48, and made integrally with bearer 18, that extend away from sensor element 20. On a side of bearer 18 facing away from sensor element 20, sensor housing 12 is situated on a measurement chamber adapted as pressure line 51, and can, as shown in FIG. 8, be sealed by pressure line 51. In particular, a pressure connection 14 is adapted integrally with pressure line 51, and can be set into walls 50 such that it extends to bearer 18 and is connected thereto in pressure-tight fashion, or against the medium in pressure line 51, both in the region around opening 48 in bearer 18 and also in the region of walls 50 of bearer 18. This can be achieved for example by gluing or welding. It is also possible, alternatively or in addition, to provide a molded seal between pressure connection 14 and walls 50. Alternatively, pressure connection 14 can be omitted and replaced by a direct connection of bearer 18 to pressure line 51. Because pressure connection 14 is situated in sealed fashion, the medium from pressure line 51 cannot move into the hollow space, formed between pressure line 51 and bearer 18, of sensor housing 12, in which circuit board 22 with the sensitive evaluation circuit is situated. Circuit board 22 is therefore situated inside sensor housing 12, which is sealed on one side by pressure line 51. The first pressure to be measured can therefore move through pressure connection 14 to sensor element 20. The second pressure acts on the rear side of bearer 18, or of sensor element 20. In order to achieve this, a pressure connector 52 of a pressure line 54, which can contain a pressurized medium, can extend from the side of bearer 18 facing sensor element 20, into depression 47 of bearer 18, and can be placed therein. In order to produce the counter-pressure on sensor element 20, the medium pressurized with the second pressure can therefore be guided from pressure line 54 through pressure connector 52 onto sensor element 20, or the rear side thereof. In particular, pressure connector 52 can either be connected directly to the base plate of housing 12 in the area of depression 47, or pressure line 54 can, as shown in FIG. 8, have at least one flange 55 that is situated surrounding pressure connector 52 and is connected to housing 12 such that a space filled with the medium pressurized with the second pressure is formed between bearer 18 and pressure line 54, and sensor housing 12 is sealed at the side of bearer 18 facing sensor element 20. In other respects, the measurement design for pressure acquisition is the same as was described in relation to the first exemplary embodiment.

FIG. 9 shows a ninth exemplary embodiment of a pressure sensor system 900 according to the present invention. In the following, only the aspects differing from the previous exemplary embodiments are described. In particular, identical components are provided with identical reference characters.

In pressure sensor system 900 shown in FIG. 9, sensor housing 12 is made of plastic, as in the seventh and eighth exemplary embodiments. However, the plastic housing of the eighth exemplary embodiment can be also converted in modified form for example for low to medium differential pressures, i.e., pressures up to 20 bar. Pressure connection 14 is not shown for simplicity. Housing base 16 and sensor housing 12 are adapted integrally, housing base 16 acting as bearer 18 for sensor element 20. In particular, housing base 16 has an opening 48 according to the eighth exemplary embodiment that is covered by sensor element 20. In addition, housing base 16 has a passage 56 connected to opening 48, the passage being adapted in housing base 16 and extending laterally through the wall of sensor housing 12. In the region of the wall of sensor housing 12, the passage opens in a pressure line 54 that is connected to the wall and that can contain a pressurized medium. Circuit board 22 with the evaluation circuit can be situated on the side of housing base 16 in sensor housing 12 facing sensor element 20. Here, circuit board 22 can be situated above sensor element 20 and above passage 56. In order to produce the counter-pressure on sensor element 20, the medium pressurized with the second pressure can therefore be routed from pressure line 54 through passage 56 in housing base 16 onto sensor element 20, or the rear side thereof. Due to the formation of passage 56 in housing base 16, it is not necessary to provide a seal between pressure line 54 and the hollow space in the interior of sensor housing 12, and the medium from pressure line 54 cannot move into the hollow space of sensor housing 12 in which circuit board 22 with the sensitive evaluation circuit is situated. In particular, a routing of pressure line 54 through the hollow space of sensor housing 12 can be omitted. Sensor housing 12 can have, as does sensor housing 12 of the seventh exemplary embodiment, an opening that can be closed by a cover. In other respects, the measurement design for pressure acquisition is the same as that described in relation to the first exemplary embodiment.

The pressure sensor system according to the present invention can include numerous further modifications and design alternatives. Housing base 16 can have any shape, in particular quadratic, rectangular, polygonal, e.g., pentagonal, octagonal, decagonal, or the like. The material can be metal, metal compounds, alloys thereof, and the like. Bearer 18 of sensor element 20 can be made of a ceramic material, plastic, or the like. Circuit board 22 can include any type of evaluation circuit suitable for contactless energetic coupling with sensor element 20, such as an application-specific integrated circuit. The contacting to the plug area can take place using any type of suitable connection, such as wires, and can take place by gluing, welding, crimping, flanging, or the like. Sensor element 20 can be any type of suitable sensor element 20, and can for example include a semiconductor silicon chip. In particular in the case of liquid media, sensor elements 20 are acted on by the second pressure. For pressures below 100 bar, sensor element 20 can be a semiconductor silicon chip, and for pressures greater than 100 bar, sensor element 20 can be a steel membrane in which the above-described components of a sensor element 20 are integrated. Depending on the application, it would also be conceivable to use ceramic elements for sensor element 20. In particular for high-pressure applications, a suitable layer construction and high geometric tolerance requirements are possible for sensor element 20 in order to make it possible to withstand the pressures. This can be achieved through a suitable choice of the materials for sensor element 20.

In the following, there is a description of a method for producing a pressure sensor system 10 according to the present invention, which in its basic features holds for all the exemplary embodiments described above, and which can be adapted to the respective exemplary embodiment geometrically and with regard to the material.

Fundamentally, sensor element 20 is attached on a bearer 18. The attachment of sensor element 20 on bearer 18 can take place in particular by soldering, glazing, or gluing, such that it can be exposed to a medium in order to measure a pressure of a medium. Depending on the exemplary embodiment, a housing base 16 can also act as bearer 18. Bearer 18 can be connected to further components, such as a pressure connection 14 and/or a housing base 16, for example in the shape of a hexagon, by soldering, welding, or the like. An evaluation circuit is subsequently provided for outputting a signal that indicates the pressure acting on sensor element 20, the evaluation circuit being situated outside the medium and energetically connected in contactless fashion to sensor element 20. This provision can take place for example by gluing. The contactless energetic connection can, as described above, take place through an inductive connection. Bearer 18 is subsequently connected to a sensor housing 12, by gluing, welding, soldering, or the like, such that the evaluation circuit is situated inside sensor housing 12 and can therefore be protected. The evaluation circuit can then be connected to a plug region, and can thus produce an electrical contacting to an external region of sensor housing 12. The contacting can take through a material bond, for example by welding or soldering, or with a positive fit, for example by flanging.

If bearer 18 of sensor element 20 is in particular made of a ceramic material and the further component on which bearer 18 is fastened, such as a pressure connection 14, is made of metal, or steel, then the connection between them so as to be sealed against the medium can take place in particular by soldering or welding. In the case of welding of such a connection, there takes place a brief, intensive heating of the components up to the melting of the components made of metal, in particular steel, and/or made of ceramic, which, in such a connecting process, can also be referred to as joining partners. The brief, intensive heating can take place through induction or by using a laser beam. If warranted, a welding additive material may be required between these components. This can be achieved for example by metallizing a surface of bearer 18 in the region of the connection.

If the named components are connected by soldering, then at the component made of metal, or steel, there takes place a brief, intensive heating up to melting of the solder between the component made of metal, or steel, and the ceramic, and a subsequent cooling. Here as well, the brief, intensive heating can take place through induction or by using a laser beam.

For both types of connection, care is to be taken that during the heating using a laser beam there is a uniform temperature gradient with regard to the overall component. This can for example be achieved by rotating the component, ensuring a uniform bond between the named materials.

1-10. (canceled)

11. A pressure sensor system for acquiring a pressure of a fluid medium in a measurement chamber, comprising:
a sensor housing,
at least one sensor element that is situated on a bearer such that the sensor element can be exposed to the medium in order to measure the pressure of the medium, and
an evaluation circuit adapted for outputting a signal that indicates the pressure acting on the sensor element, the evaluation circuit being situated outside the medium and being energetically connected to the sensor element in contactless fashion,
wherein the bearer is connected to the sensor housing such that the evaluation circuit is situated inside the sensor housing.

12. The pressure sensor system according to claim 11, wherein the bearer is made of an electrically nonconductive material.

13. The pressure sensor system according to claim 11, wherein the bearer is permeable to magnetic fields.

14. The pressure sensor system according to claim 11, further comprising:
a pressure connection to which the bearer of the sensor element is connected so as to be sealed against the medium.

15. The pressure sensor system according to claim 14, wherein the bearer is made of a ceramic material, and the pressure connection is made of a metal or a metal compound.

16. The pressure sensor system according to claim 14, further comprising:
a housing base that is situated on an end of the pressure connection, the bearer of the sensor element being provided on the pressure connection such that the bearer stands out from a plane of the housing base, or is situated in a plane of the housing base.

17. The pressure sensor system according to claim 11, wherein the evaluation circuit is situated directly on the bearer of the sensor element.

18. The pressure sensor system according to claim 11, wherein a further pressurized medium is situated in the sensor housing, so that a counter-pressure can be applied to the bearer of the sensor element, and the pressure sensor system is adapted for a differential pressure measurement.

19. A method for producing a pressure sensor system, comprising:
attaching a sensor element on a bearer by soldering, glazing or gluing, such that the sensor element can be exposed to a medium in order to measure a pressure of the medium,
providing an evaluation circuit for outputting a signal that indicates the pressure acting on the sensor element, the evaluation circuit being situated outside the medium and being energetically connected to the sensor element in contactless fashion, and
providing a sensor housing,
wherein the bearer is connected to the sensor housing such that the evaluation circuit is situated inside the sensor housing.

20. The method according to claim 19, further comprising:
providing a pressure connection made of metal,
wherein the bearer of the sensor element is made of a ceramic material and is connected to the pressure connection so as to be sealed against the medium by soldering, welding or gluing.
